(19) United States
(12) Patent Application Publication
(10) Pub. No.: US 2026/0128013 A1
(43) Pub. Date: May 7, 2026

(54) Active Direct Driving of Pixels in Display, Signaling and Digital Signage Devices

(71) Applicants: Mattrix Technologies, Inc., Gainesville, FL (US); JSR CORPORATION, Tokyo (JP)

(72) Inventors: Hiromitsu Katsui, Yokkaichi (JP); Xiao Chen, Gainesville, FL (US); Bo Liu, Gainesville, FL (US); Svetlana Viktorovna Vasilyeva, Gainesville, FL (US); Maxime Gregory Lemaitre, Newberry, FL (US)

(21) Appl. No.: 19/369,949

(22) Filed: Oct. 27, 2025

Related U.S. Application Data
(60) Provisional application No. 63/712,694, filed on Oct. 28, 2024.

(51) Int. Cl. G09G 3/3258

(52) U.S. Cl. CPC G09G 3/3258; G09G 2300/0408; G09G 2300/0426; G09G 2300/0439; G09G 2320/0626

(57) ABSTRACT

Various examples are provided related to active direct driving of pixels. In one example, an active direct driving matrix device includes VOLET pixels arranged to form an emissive display; bus lines including at least one VDD line routed along edges of the VOLET pixels and VDATA lines routed under the VOLET pixels, each VOLET pixel connected to a corresponding VDATA line of the VDATA lines. In another example, a method of fabricating an active direct driving matrix device includes forming a first layer of VDATA lines over a substrate; depositing a first insulating layer over the first layer of VDATA lines; forming a second layer of VDATA lines over the first insulating layer; depositing a second insulating layer over the second layer of VDATA lines; and forming VOLET pixels over the second insulating layer, each VOLET pixel electrically connected to a corresponding VDATA line.

### CROSS REFERENCE TO RELATED APPLICATIONS

This application claims priority to, and the benefit of, U.S. provisional application entitled “Active Direct Driving of Pixels in Display, Signaling and Digital Signage Devices” having Ser. No. 63/712,694, filed Oct. 28, 2024, which is hereby incorporated by reference in its entirety.

### BACKGROUND

Automotive vehicles are equipped with multiple sets of external lighting fixtures essential for safety, signaling, and visibility. The evolution of vehicle external lighting has seen significant technological advancements, from the early use of incandescent bulbs to the more efficient halogen lamps. The industry experienced a revolutionary leap with the introduction of Light Emitting Diodes (LEDs), which offered superior longevity, lower energy consumption, and greater design flexibility. Modern innovations like Organic Light Emitting Diodes (OLEDs) and laser lighting technology continue to push the boundaries, providing precise lighting control and new integration possibilities into vehicle bodywork.

### SUMMARY

Aspects of the present disclosure are related to active direct driving of pixels in, e.g., display, signaling and digital signage devices. In one aspect, among others, an active direct driving matrix device, comprises an array of VOLET pixels arranged to form an emissive display; bus lines comprising at least one VDD line routed along edges of the array of VOLET pixels and a plurality of VDATA lines routed under the array of VOLET pixels, each VOLET pixel of the array of VOLET pixels connected to a corresponding VDATA line of the plurality of VDATA lines. In one or more aspects, the array of VOLET pixels can share a common VDD-cathode voltage difference through the at least one VDD line. The plurality of VDATA lines and at least one VDD line can be routed in different directions to a periphery of the emissive display. The array of VOLET pixels can be arranged in rows and columns, with one or more VDD line extending along each row and the plurality of VDATA lines comprising corresponding VDATA lines extending to each VOLET pixel in that column. The corresponding VDATA lines extending to each VOLET pixel in a column can extend a different length under the VOLET pixels in the column. The corresponding VDATA lines extending under the VOLET pixels in the column can comprise at least two layers of corresponding VDATA lines separated by an insulating layer. The VDATA lines of the at least two layers can be aligned, and can be overlapping when viewed from a direction perpendicular to an emission surface of the VOLET pixel. The VDATA lines of the at least two layers can be aligned, and can have offsets without overlapping when viewed from a direction perpendicular to an emission surface of the VOLET pixel. The VDATA lines of the at least two layers can be perpendicular between adjacent layers when viewed from a direction perpendicular to an emission surface of the VOLET pixel. In some aspects, a connection between a VOLET pixel and its corresponding VDATA line in one of the at least two layers can comprise a stacked-via structure, the stacked-via structure comprising a plurality of vertically aligned vias extending through insulating layers separating the at least two layers of corresponding VDATA lines. A connection between a VOLET pixel and its corresponding VDATA line in one of the at least two layers can comprise a staggered-via structure, wherein vias connecting successive conductive layers are laterally offset from one another. A connection between a VOLET pixel and its corresponding VDATA line in one of the at least two layers can comprise a semi-staggered via structure, wherein vias are vertically aligned across a first set of adjacent insulating layers and are laterally offset across a second set of adjacent insulating layers. The corresponding VDATA lines can extend from opposite sides of the array of VOLET pixels.

In various aspects, the plurality of VDATA lines can comprise a transparent conductive oxide or transparent conducting film. Brightness of each VOLET pixel in the array of VOLET pixels can be compensated based upon number of VDATA lines under that pixel. The active direct driving matrix device can comprise a plurality of dummy VDATA lines routed under the array of VOLET pixels, wherein a combined number of VDATA and dummy VDATA lines routed under each VOLET pixel of the array of VOLET pixels is equal. The plurality of dummy VDATA lines can be patterned to substantially replicate a layout of the plurality of VDATA lines to normalize a parasitic capacitance or an optical transmittance for each VOLET pixel in the array of VOLET pixels. The dummy VDATA lines can be electrically floating or can be connected to a fixed potential. Each VOLET pixel can be visibly discernable to a user. Each VOLET pixel can have a shape of a triangle. Each VOLET pixel can comprise an arbitrary closed shape. The array of VOLET pixels can consist of pixels with a variety of shapes. Each VOLET pixel can be visibly not discernable to a user. In one or more aspects, the active direct driving matrix device can be formed on a common substrate, wherein a first portion of VOLET pixels can be visibly discernable to a user, while a second portion of VOLET pixels can be not visibly discernable to the user. A plurality of VOLET pixels can be grouped together by connecting to VDD lines that are tethered together only within each group, and each group can share a common VDD-cathode voltage difference through the tethered VDD lines within its group. Each group of VOLET pixels can have the same or roughly similar number of pixels, and a pixel in one group can be connected to a common VDATA line that is also connected to one pixel in another or each of the other groups of pixels. A drive timing scheme can allow one group of VOLET pixels to be activated by a non-zero common VDD-cathode voltage difference through the tethered VDD line, while some or all of the other groups of VOLET pixels can be deactivated by a common VDD-cathode voltage difference that is set to zero (0) through the tethered VDD lines. The VDD lines tethered together within each group can be routed in a mesh configuration to improve voltage uniformity across the group. The at least one VDD line can be routed in a mesh configuration to improve voltage uniformity across the group. VDATA voltage signals applied to the array of VOLET pixels can be only updated as needed by display content rather than frame by frame. The VDATA voltage signals applied to any given VOLET pixel can be a combination of continuous and pulsed voltages. In some aspects, VDATA voltage signals can be pulsed with a certain periodicity and duty cycle to allow the VOLET pixels to alternate between a non-emission state and an emission state of a certain magnitude, wherein VDATA pulse duration and voltage level both determine the overall average brightness of a given VOLET pixel. The VDATA voltage signal of each of the array of VOLET pixels can be adjusted in proportion to an expected current and luminance efficiency decay of a VOLET stack. The VDATA lines can be disposed in a plurality of layers separated by interlayer dielectrics, and wherein the connection from a VOLET pixel to its corresponding VDATA line can comprise a single deep via extending through the plurality of interlayer dielectrics.

In another aspect, a method of fabricating an active direct driving matrix device comprises forming a first layer of VDATA lines over a substrate; depositing a first insulating layer over the first layer of VDATA lines; forming a second layer of VDATA lines over the first insulating layer; depositing a second insulating layer over the second layer of Vdata lines; and forming an array of VOLET pixels over the second insulating layer, wherein each VOLET pixel is electrically connected to a corresponding VDATA line in at least one of the first or second layers of VDATA lines. In one or more aspects, forming the electrical connection can comprise forming a stacked-via structure by: etching a first via through the first insulating layer to expose a VDATA line in the first layer; forming a first conductive plug in the first via; etching a second via through the second insulating layer, wherein the second via is substantially vertically aligned with the first via, to expose the first conductive plug; and forming a second conductive plug in the second via. In various aspects, forming the electrical connection can comprise forming a staggered-via structure by: etching a first via through the first insulating layer to expose a VDATA line in the first layer; forming a conductive pad on the first insulating layer that fills the first via and extends laterally; and etching a second via through the second insulating layer to expose a portion of the conductive pad that is laterally offset from the first via.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIGS. 1A and 1B schematically illustrate an example of a vertical organic light emitting transistor (VOLET) and carbon nanotube (CNT) network source electrode transmittance spectrum, in accordance with various embodiments of the present disclosure.

FIG. 2 illustrates a schematic diagram of an active direct driving pixel circuit, in accordance with various embodiments of the present disclosure.

FIG. 3 illustrates an example of an active direct driving display circuit connection scheme, in accordance with various embodiments of the present disclosure.

FIGS. 4A and 4B illustrate a comparison of refresh mechanisms of an AMOLED display and an active direct driving OLED display (ADD-OLED), in accordance with various embodiments of the present disclosure.

FIG. 5 illustrates examples of VOLET display pixels at various locations in an Active Direct Driving OLED display, with transparent data voltage lines routing underneath the pixels, in accordance with various embodiments of the present disclosure.

FIGS. 6A-6C illustrate examples of multi-layer VDATA line structures, with different VDATA line arrangements, in accordance with various embodiments of the present disclosure.

FIGS. 6D-6J illustrate examples of electrical connections between VDATA lines, in accordance with various embodiments of the present disclosure.

FIGS. 7A and 7B illustrate examples of ADD-OLED panels for top and top/bottom emission, in accordance with various embodiments of the present disclosure.

FIG. 8 illustrates an example of an addressing scheme of an ADD-OLED display, in accordance with various embodiments of the present disclosure.

FIGS. 9A and 9B illustrate an example of extending ADD-OLED displays by timing blocks, in accordance with various embodiments of the present disclosure.

FIGS. 10A and 10B illustrate an example of a bottom emission VOLET pixel in an ADD-OLED display panel and effect of compensation, in accordance with various embodiments of the present disclosure.

FIG. 11 illustrates an example of light emission without (left) and with (right) the inclusion of dummy VDATA lines under ADD-OLED pixels, in accordance with various embodiments of the present disclosure.

FIG. 12 illustrates an example of a display with right triangle pixels that utilize the ADD-OLED architecture, in accordance with various embodiments of the present disclosure.

FIGS. 13A-13B and 14A-14B illustrate examples of fabrication processing to manufacture VOLET based Active Direct Driving OLED displays, in accordance with various embodiments of the present disclosure.

### DETAILED DESCRIPTION

Disclosed herein are various examples related to active direct driving of pixels in, e.g., display, signaling and digital signage devices. Reference will now be made in detail to the description of the embodiments as illustrated in the drawings, wherein like reference numbers indicate like parts throughout the several views.

Today's vehicle lighting systems extend beyond basic operational needs, serving as a platform for brand differentiation and embodying high-tech luxury. Automakers leverage distinctive lighting designs as visual signatures that are instantly recognizable and associated with their brand image. Sophisticated adaptive lighting systems enhance safety, enable new communication functionality, and reinforce the perception of quality and luxury. As vehicle communication technology advances, especially with autonomous vehicles, lighting and signaling systems are increasingly tasked with conveying complex information to pedestrians, ensuring safe interactions in the absence of traditional driver cues. This evolution calls for innovative devices that merge rich information display with cutting-edge technology and luxury, redefining the role of lighting in automotive design.

To address the growing demand for advanced automotive lighting and signaling systems, a new type of device has been proposed (see, International Publ. No. WO 2025/122930, entitled “Hybrid Active-Passive Matrix Devices for Displays, Lighting and Signaling,” having International App. No. PCT/US2024.058964, filed Dec. 6, 2024, which is hereby incorporated by reference in its entirety): an automotive external display enabled by VOLET technology. This innovative device offers a high fill factor, providing a luxury feel while supporting rich design concepts. Unlike conventional display panels with indistinguishable pixels, the proposed display features larger, uniquely designed pixels that form visible and discernible patterns. These patterns can display shapes, symbols, letters, words, sentences, and other meaningful visual cues. This functionality is essential for signaling the vehicle's intentions, providing guidance to other vehicles and pedestrians, showcasing the vehicle's style and design features, and even displaying advertising content.

Expanding on this concept, a hybrid VOLET automotive external display with mixed pixels and a monolithic hybrid VOLET/OLED automotive external light and display with mixed pixels and segments have also been proposed. These devices feature regions with traditional display pixels that are active-matrix addressed and indistinguishable, alongside larger segments that are passive-matrix addressed or directly driven by bus lines. The entire device can be fabricated using the same process on various substrates, whether glass, plastic, or other rigid or flexible materials. This includes the backplane process and the VOLET-specific layers. OLED or other light emission layers, such as quantum dot LED (QD-LED), can be integrated during the same process or in separate runs for different regions.

### OLED Displays: Passive-Matrix and Active-Matrix

For conventional OLED display panels with a large number of pixels, there are generally two types of driving schemes: active-matrix driving and passive-matrix driving. Active-matrix displays employ a thin-film transistor (TFT) backplane to control each pixel individually, providing precise control over the display. In this scheme the data signal is refreshed row by row, such that all the pixels in each row are updated simultaneously. This method offers high resolution, better refresh rates, and superior image quality, making it ideal for complex displays requiring high resolution. However, the necessity for a TFT backplane to drive and control the brightness of each OLED pixel involves a complex TFT semiconductor fabrication process, leading to increased production costs and poor yields, especially for large display panels.

On the other hand, passive-matrix driving uses a simple grid of electrodes to control the pixels. While this method is more cost-effective and easy to manufacture, it generally results in lower resolution, lower brightness and slower refresh rates. Passive-matrix displays are more prone to ghosting effects, where images persist longer than desired, and are less power efficient compared to active-matrix displays.

For some applications, such as the aforementioned automotive display featuring larger, uniquely designed pixels that form visible and discernible patterns, the passive-matrix scheme may fall short in delivering adequate performance. While active-matrix driving can provide better performance, the inclusion of TFTs significantly increases costs. In applications where pixel counts are below a certain threshold, it would be advantageous to eliminate the need for TFTs to reduce costs. In these cases, it would be highly beneficial to develop a display panel that can be fabricated using a process similar to the passive-matrix approach. This process would involve only conductive traces of metal and/or transparent conductive oxide (TCO), avoiding the expensive and complex TFT fabrication process, thereby achieving cost-effective manufacturing while still be able to deliver good performance.

Efforts to reduce the production cost of a display panel should not come at the expense of reduced performance. There is a desire to still want to maintain the benefits provided by advanced active matrix displays, including:
1. Continuous Emission: Maintaining the brightness of the pixels throughout the refresh cycle.
2. Variable Refresh Rate: Allowing for both a fast response rate when needed and a reduced power consumption mode at a lower refresh rate.
3. Large Aperture Ratio: Boosting brightness and prolonging the display's lifetime.

### Design Considerations for Display Pixel Driving

To achieve these goals, there is a need to analyze the design restrictions of a multi-pixel display and find solutions that work within these constraints. There are several limitations faced by a display panel composed of a matrix of pixels, for example, N columns by M rows:
1. Bus Line Routing Limitation: Each pixel needs bus lines for either power delivery, data signal feeding, or both, to be connected in some way. If each pixel were addressed directly, the number of bus lines needed would be proportional to the value of N×M. For large values of N and M, this would result in a very high number of densely packed bus lines, making it practically impossible given the available surface area for bus line routing.
2. Current Carrying Capacity Limitations: Bus lines are typically formed by thin films of conductive material such as metal or TCO, which have limited conductivity. Driving OLEDs, especially at high brightness, requires a large current. However, bus lines with limited conductivity will not be able to provide such a current at a reasonable voltage, especially when combined with other restrictions, including limited bus line width and requirements for transparency, which further reduce the current-carrying capacity of bus lines.
3. Driving and Refresh-rate Limitations: Achieving smooth video playback without motion blur artifacts requires a fast refresh rate. On the other hand, a more energy efficient strategy would be to only refresh pixels as needed for example if the content is changing. This is because refreshing the entire screen every cycle consumes a significant amount of power. To achieve this, pixels needs to be capable of maintaining their brightness level between extended refresh cycles. This enables the refresh rate of the screen to be low when the screen content does not require updates, while still enabling pixels to be refreshed at a high rate as demanded by fast changing content.

The passive-matrix display prioritizes a simple manufacturing process and low cost but fails to adequately address certain performance limitations. Pixels in a passive-matrix display cannot maintain their brightness between refreshing cycles (pixels in a given row are only “on” for a brief period defined by the period of a refresh cycle divided by the number of rows), leading to lower performance. In contrast, the active-matrix display uses thin-film transistors (TFTs) to drive the OLEDs, enabling pixels to maintain their brightness more consistently.

In a conventional TFT-driven AMOLED, the basic pixel circuit comprises a switching TFT (sw-TFT), a drive TFT (dr-TFT), a storage capacitor, and an OLED. The TFTs in the backplane serve two primary functions: (1) the dr-TFT provides current to the OLED in proportion to the desired brightness, and (2) the sw-TFT transmits voltage signals that control the current level during each frame. The sw-TFT transmits voltage signals from the data line (VDATA signal) to charge a capacitor during the pixel refresh step, holding that charge to maintain the voltage on the gate of the dr-TFT throughout the refresh cycle.

The performance demands on the dr-TFT in an AMOLED pixel are significantly higher than for the sw-TFT. The dr-TFT needs to have a sufficiently high mobility to provide the current needed to drive the OLED pixels. Additionally, it needs excellent stability without threshold voltage (Vth) shift under all driving conditions to maintain steady, consistent pixel brightness. For a uniform display panel without visible mura, the characteristics of the dr-TFTs across all pixels needs to be consistent.

Replacing Dr-TFT with VOLET and Eliminating Sw-TFT

The dr-TFT is an important component in a conventional AMOLED pixel, responsible for continuously supplying current to drive the OLED. If the dr-TFTs are eliminated, then a current source on the periphery needs to be able to supply a finely controlled and stable current via a highly conductive bus lines to each OLED pixel. These requirements are challenging to meet.

Providing a current source that delivers accurate current with fine modulation is difficult. Furthermore, having a current source for every pixel in a display panel is even more challenging. A bus line that routes into each pixel in a display panel needs to be sufficiently conductive to sustain a large current at relevant voltages. Combining these two factors makes it extremely challenging to use simple bus lines connected to external current sources to feed current into each pixel for the attempt of replacing the dr-TFT.

Conversely, replacing the sw-TFT is comparatively easier. Although its role is also essential, it only remains in the “on” state for a short period and does not need to drive high current. Instead, it primarily transmits voltage signals and provides enough current to charge the storage capacitor in each pixel. Thus, substituting the sw-TFT with external voltage sources and directly connected bus lines is more feasible, even if a large number of both is required to feed each and every pixel.

It is straightforward to implement multiple channels for voltage signals. Modern display drivers already feature thousands of channels providing high-accuracy voltage signals. Secondly, the bus lines used to transmit the voltage signal do not need to be as conductive as lines that those that transmit currents, which eases the space and process constraints associated with forming high-conductance bus lines.

We can take this a step further and replace the dr-TFT, storage capacitor, and OLED with a VOLET. In this case, the bus line transmits a data signal voltage directly to the gate of the VOLET to regulate light emission directly. This allows us to create a pixel circuit with just one component, and without the need for any additional TFT processing steps or materials.

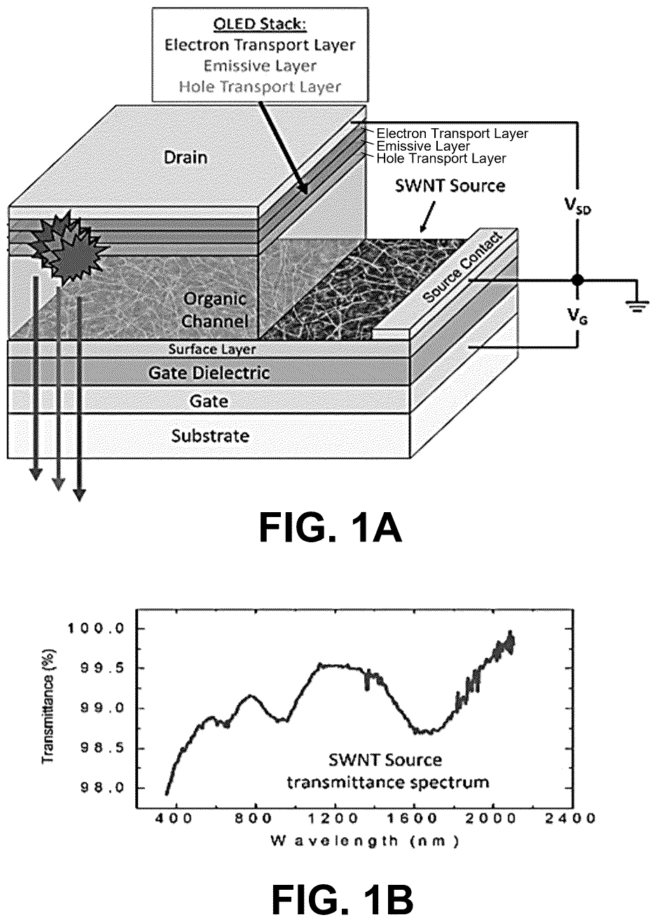

The VOLET is a three-terminal device in which the gate, source, and drain electrodes are oriented in a vertical stack. The core of the VOLET is a dilute CNT network source electrode that covers the entire gated area of the device while featuring microscopic open areas between conductive elements. Single-walled carbon nanotubes (CNTs), with their long aspect ratios, high electrical conductivity, solution processability, and low density of electronic states, are a material of choice for the network source electrode (porous graphene or other semimetals and certain metallic and semiconducting nanowires are also candidates). The semiconductor thin film channel material deposited on top of the network source electrode is selected to have a proper carrier injection barrier with the CNTs source electrode. The open regions of the network structure allow for the penetration of the gate field up to the contact interface between the source and the channel semiconductor, modulating the injection barrier between them, which dictates the current flowing through the device. Unlike in a conventional TFT where current flows along the interface between the channel and the gate insulator, laterally across the channel length from the source to the drain, in the VOLET the current flows vertically through the entire cross-section of the channel layer, where the channel length is now defined by the thickness of the semiconductor thin film. FIG. 1A shows a schematic view of a VOLET and FIG. 1B shows a CNT network source electrode transmittance spectrum.

With the novel VOLET, a new pixel wiring and addressing scheme is proposed that can achieve performance comparable to active-matrix systems without the high costs associated with TFT backplanes. This approach would not only simplify the manufacturing process but also make it more cost-effective, including for applications that employ visible and discernible pixel patterns rather than high pixel density. Ultimately, this could lead to more affordable and versatile automotive displays that still meet the high performance and design standards required for modern vehicles. Additionally, this innovation could open doors for broader applications, including information signaling and digital signage.

### Active Direct Driving

A new pixel wiring and addressing scheme that can achieve a display that offers performance comparable to active-matrix systems, without incurring the high costs associated with TFT backplanes, that can be suitable for various forms of automotive external display, signaling and lighting devices is presented. The unique characteristics of the innovative VOLET device architecture enables the approach.

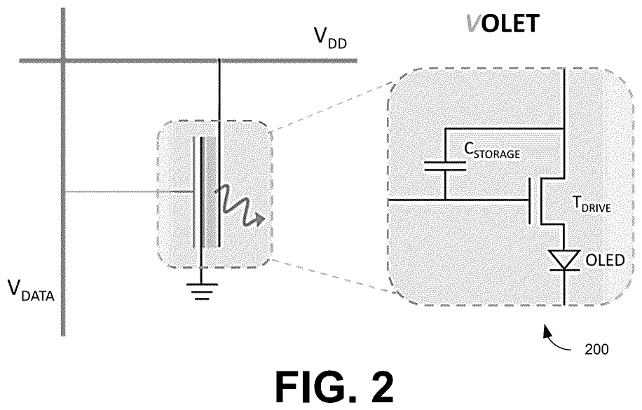

With VOLET, it is possible to build this new type of driving scheme, that is in between Active-Matrix driving and Passive-Matrix driving, which is referred to as Active Direct Driving. FIG. 2 illustrates a schematic diagram of an active direct driving pixel circuit 200. In this new driving scheme, all VOLET pixels, or segments of the display can have a common anode connected to the VOLET CNT source electrodes, and a common cathode, while each VOLET pixel or segment has its gate electrode directly addressed by a metal or transparent conductive oxide (e.g., ITO) bus line. These bus lines are directly connected to data-voltage sources, which would be multi-channel analog output sources of various types, including typical display source driver ICs. In this configuration, the operation of the panel is much closer to an Active-Matrix, in that all pixels are always supplied with power, and thus will stay active between refresh cycles. Refreshing the image is done by updating the data signal sent to each VOLET gate.

The VOLET is the core in the pixel circuit, providing the light emission of the pixel, as well as brightness control over the pixel. The three terminals of the VOLET are connected to VDD (drain), VGND (source), and VDATA, respectively. The potential difference between VDD and VGND provide driving voltage to power the light emission, while the VDATA, connected with the gate terminal of the VOLET, provides the control signal of the VOLET to modulate light emission.

### Common-Anode and Common-Cathode Connection of VOLET Pixels

In an Active Direct Driving display panel with VOLET pixels, the circuit connection is very different from either Passive-Matrix or Active-Matrix display panels. In the most general configuration, all pixels are connected with a common-anode and common-cathode while every VOLET pixel features its own VDATA line directly connected to the VOLET gate terminal, and routed to the outside edge of the panel display area.

The voltage difference between the VDD and VGND are maintained at a constant value by a power supply which is capable of delivering high current through the OLED layers while maintaining the voltage to meet the demand of current draw of all pixels in the panel even at peak brightness of the panel when every pixel is emitting at the peak brightness level.

### Individual VDATA Connection for Direct VOLET Control: Enabling Active Direct Driving

With the voltage difference between VDD and VGND held at constant level, the brightness of each VOLET pixel is controlled by the VDATA voltage at its gate terminal. Each VOLET pixel has its own connection by an individual conductive trace routed from the pixel to outside of the panel display region. A voltage signal source outside the panel display region provides the necessary voltage signal to the gate terminal of the VOLET, controlling the brightness level of the VOLET pixel by controlling the VOLET emission.

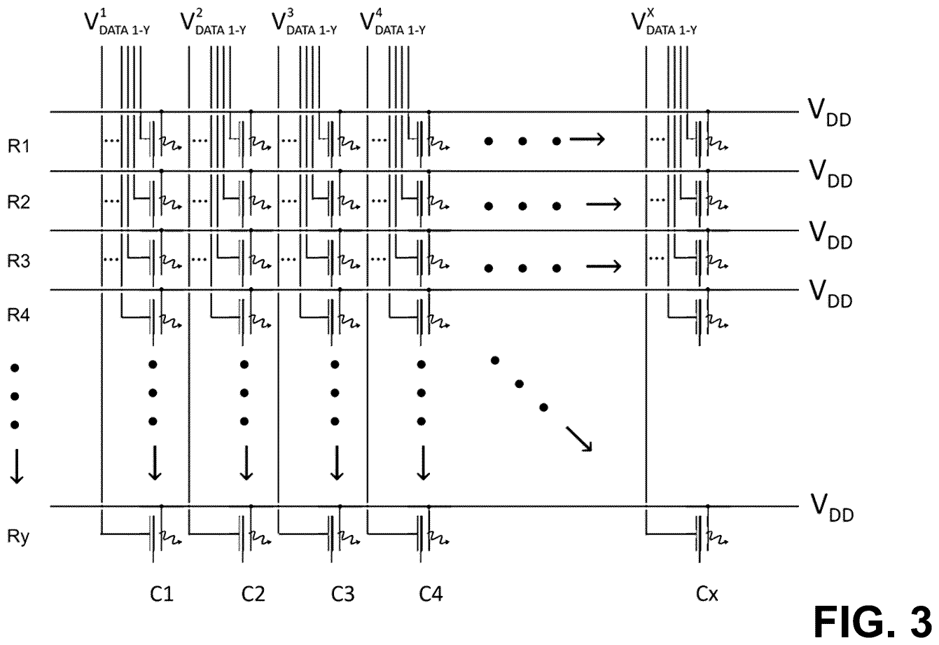

FIG. 3 is a schematic diagram illustrating an example of an active direct driving display circuit connection scheme, with y rows (R1 to Ry) by x columns (C1 to Cx) of pixels forming the display panel. Each pixel features a VOLET, that shares the common cathode voltage though VDD lines that are all connected together. The VOLET in each pixel has a dedicated VDATA. Without losing generality, the VDATA lines are routed along the column direction, from Ry towards the direction of R1, and out of the display area to then connect to data voltage sources. It is apparent that from Ry to R1, the number of VDATA lines that need to route out within each column would increase, and at the edge of display there would be y VDATA lines that exit the display region within the area of each column of pixels.

This is very different from an Active-Matrix OLED display, where all pixels in a column share a common data bus line. Due to this data bus line sharing, each pixel requires a switching TFT (sw-TFT). Precise timing is crucial, as the common data bus line needs to be fed with the correct data voltage level while the sw-TFT for the pixel is turned on to access the data signal. The signals for turning the sw-TFT on and off for each pixel are not independently controlled but are addressed by another bus line—the sw-TFT gate bus line—which runs perpendicularly to the data bus line. This arrangement requires a consistent refresh rate for the entire panel.

With advanced display technologies, such as Low-Temperature Polycrystalline Oxide (LTPO), a lower refresh rate can be achieved. However, all sw-TFTs still need to go through this on-and-off cycle, and the data signal in the data line needs to be updated synchronously with the sw-TFT gate line switching, all of which consumes power.

In contrast, the proposed active direct driving scheme does not require the entire display to undergo a row-by-row pixel refresh cycle. The pixels are instead only updated on-demand. This eliminates the need for a timing controller to activate individual rows during the data signal refresh and reduces any associated switching and parasitic power losses.

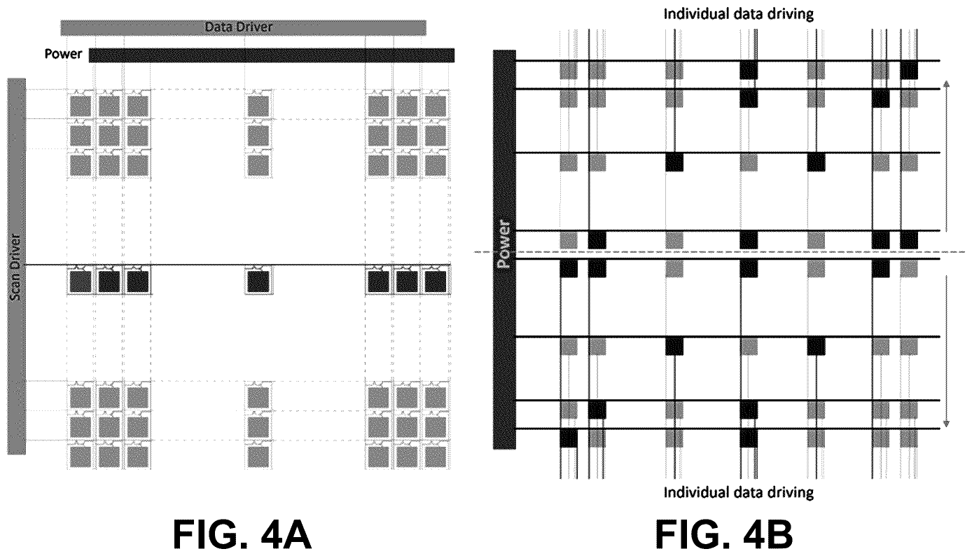

FIGS. 4A and 4B compare the refresh mechanisms of an AMOLED display and an active direct driving OLED display (ADD-OLED). FIG. 4A illustrates the refresh sequence of a conventional AMOLED display, where all pixels in a given row are simultaneously selected by turning on each of the sw-TFTs in that row. The data voltage fed to each data line corresponds to the desired brightness level for the pixel in the selected row. As a result, even if the pixel data voltage level remains unchanged in this frame, the voltage supplied to the data line needs to be modified from the previous value (associated with the pixel in the previous row). Consequently, the row-by-row scanning process of the AMOLED display panel consumes power even when the screen content changes minimally.

By contrast the ADD-OLED panel does not require a row-by-row refresh scheme, since the gate terminal of each pixel is connected to its own data line. Therefore, the refresh operation can be conducted on an individual pixel basis. This means that only the pixels needing updates will have their data voltage adjusted, while the voltage level on the data line remains unchanged for other pixels. Without current flowing, there is no power consumption, thereby minimizing the power used in refresh operations. FIG. 4B illustrates this power-saving refresh scheme, which optimizes energy efficiency.

The power savings in panel refreshing and compare the ADD-OLED with existing solutions, including LTPO, can be further discussed to demonstrate the intrinsic advantages of ADD-OLED in power efficiency. LTPO technology achieves power savings partly due to the low off-state conductance of the oxide sw-TFT, which blocks charge leakage from the storage capacitor connected to the dr-TFT gate, thereby maintaining the gate voltage level. This charge leakage is essentially a crosstalk phenomenon caused by the shared VDATA line across all pixels in a column, which needs to be fed with different VDATA voltage levels throughout the row-by-row scanning refresh sequence. This crosstalk, occurring through the sw-TFT in its off state, affects the charge level of the storage capacitor in other pixels within the same column.

The oxide sw-TFT in LTPO, with its low off-state conductance, reduces this crosstalk and thus decreases the need for frequent refreshing to replenish the charge levels of the storage capacitor, thereby reducing power consumption. However, some leakage through the sw-TFT still occurs, necessitating periodic refreshing.

In the ADD-OLED panel, since there is no sharing of the VDATA line, there is no crosstalk between the gate terminals of different pixels. Consequently, power consumption is reduced because there is no need for constant pixel refreshing. Additionally, the VDATA retention time can be considered infinitely long, as there is virtually no power consumption on the VDATA line with a stable voltage level provided by the external VDATA voltage source.

### Conductive Trace Routing Schemes for Individual VDATA Connection

In the most basic configuration, every pixel of an ADD-OLED display will have a dedicated VDATA line to supply voltage to the VOLET gate. The width and spacing of the VDATA bus lines therefore place a fundamental constraint on the panel size for a given pixel density. In other words, the size of the display is limited by the number of bus lines that can fit within the width of a pixel.

Fortunately, the data voltage signal can be transmitted to the gate terminal of the VOLET via a relatively low-conductance bus line. This allows for thinner conductive films, narrower line widths, and lower-conductivity materials, including transparent conductive oxides (TCOs) to be used for the VDATA lines.

Transparent VDATA lines (employ TCOs) have the advantage that they can be routed directly underneath the pixels without blocking light emission. The transparent VDATA lines can run down from the top edge of the display to each individual pixel with a minimum spacing between them so as to maximize the number of pixels addressable within the column. The number of pixels would therefore be limited by the number of VDATA lines (and spaces) that can be fit in a pixel width. Optionally, another set of VDATA lines could run UP from the bottom edge of the display, where they would be connected to another set of display drivers-effectively doubling the vertical dimension of the display.

An inter-layer dielectric (ILD) can be formed to separate the VDATA lines and the VOLET pixels to prevent direct electric shorting between them. Considerations can also be made on the material and parameters of the ILD to reduce the capacitance coupling between the VDATA lines and other conductive layers on top of the ILD.

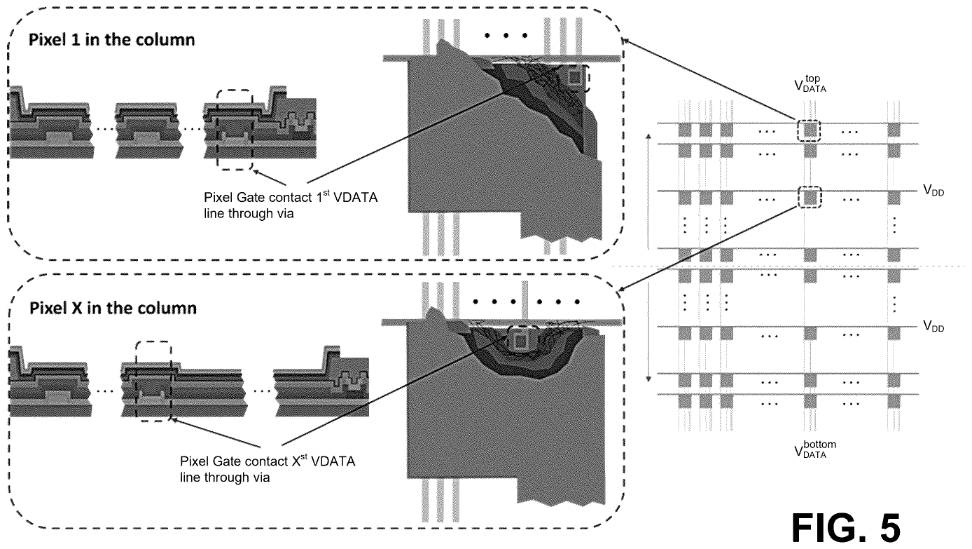

FIG. 5 shows schematics of VOLET display pixels at various locations in an Active Direct Driving OLED display, with transparent data voltage lines routing underneath the pixels. In the example shown in FIG. 5, VDATA lines are parallel with each other under every column of pixels, addressing all pixels in that column by connecting the gate terminal of the VOLET to external VDATA sources. The connection between the VDATA line and the VOLET gate terminal can be achieved by a via hole through the ILD that separates the VDATA traces and the VOLET gate. In this example, the position of the via is shifted progressively to the right as the pixel gets closer to the edge of the display.

In this basic configuration, the maximum number of VDATA traces that can fit underneath a column of pixels determines the number of pixels that can be addressed from one edge of the display. The lithography patterning process places a limitation on the minimum line and spacing widths, which determines the maximum number of lines that can fit within each column. The number of rows in a display (and therefore the display size) is ultimately constrained by the pixel width. This limits the possible display specifications that can be achieved using this basic configuration.

For example, an automotive display for lighting/signaling with visually discernable pixels would allow for a large number of VDATA traces to fit in each column. Even a relatively coarse L/S spacing of 4 μm would easily accommodate large displays (between 10 and 60 inches) suitable for automotive signaling and lighting as shown in table 1 below. The maximum display height assumes that a second set of drivers is used to connect additional bus-lines to the bottom of the display (effectively doubling the maximum size of the panel).

TABLE 1

| VDATA line | VDATA line | Pixel side | | No. of VDATA lines | Max Panel Height |
|---|---|---|---|---|---|
| width (um) | gap (um) | length (um) | PPI | (Pixel count/column) | (inch) |
| 4 | 4 | 400 | 63.5 | 50 | 1.6 |
| 3 | 3 | 400 | 63.5 | 67 | 2.1 |
| 2 | 2 | 400 | 63.5 | 100 | 3.1 |
| 4 | 4 | 1000 | 25.4 | 125 | 9.8 |
| 3 | 3 | 1000 | 25.4 | 167 | 13.1 |
| 2 | 2 | 1000 | 25.4 | 250 | 19.7 |
| 4 | 4 | 1600 | 15.875 | 200 | 25.2 |
| 3 | 3 | 1600 | 15.875 | 267 | 33.6 |
| 2 | 2 | 1600 | 15.875 | 400 | 50.4 |
| 4 | 4 | 2500 | 10.16 | 313 | 61.5 |
| 3 | 3 | 2500 | 10.16 | 417 | 82.0 |
| 2 | 2 | 2500 | 10.16 | 625 | 123.0 |

TABLE 1 calculates the number of VDATA lines (which is also the maximum number of pixels in one direction) that can fit under a column of pixels with various VDATA line width, line gap, as well as pixel side length. The PPI is calculated from the pixel side length, and the maximum panel height is calculated by assuming two such layouts are placed against each other, with the top column of pixels routing VDATA lines to the top edge of the panel, while the bottom column of pixels routing VDATA lines to the bottom edge of the panel. It is apparent that when pixel size gets larger (>1000 μm), the panel height supported would be sufficient to accommodate large panels.

### Extending ADD-OLED Displays by Multi-Layer Routing of VDATA Traces

The discussion above regarding the maximum number of addressable pixels in each column assumes that a single layer of VDATA line traces is used. It is possible to increase the number of VDATA lines that can fit under a column of pixels by increasing the number of conductive trace layers. The VDATA structure in this concept is similar to the multi-layer Redistribution layer (RDL) in the advanced packaging industry, where multi-layer conductive traces separated by interlayer dielectrics are formed to facilitate the interconnection. By the first order estimation, m layers of VDATA would provide a m-fold increase of maximum number of pixels in a column.

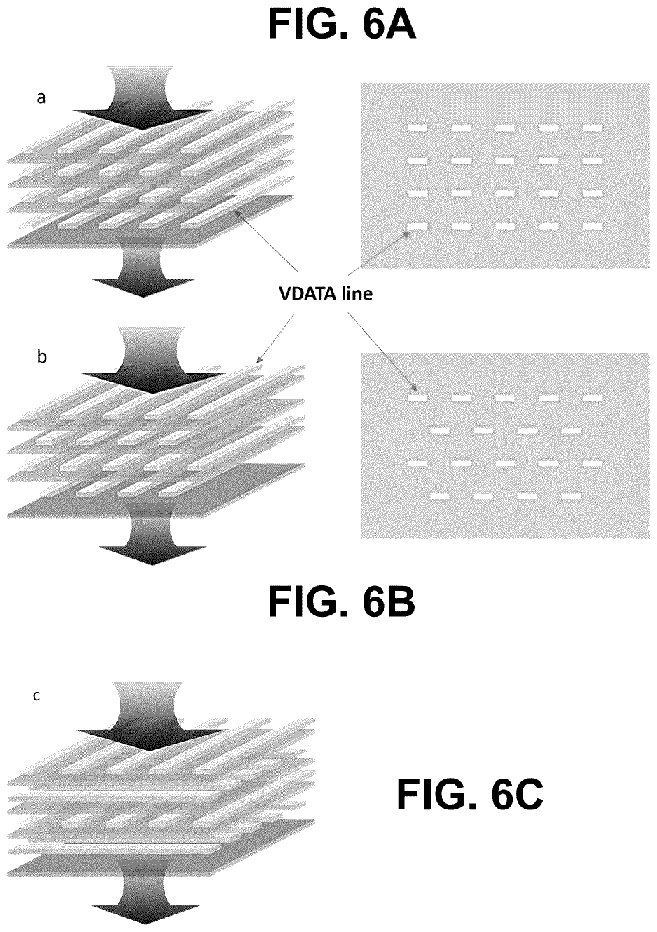

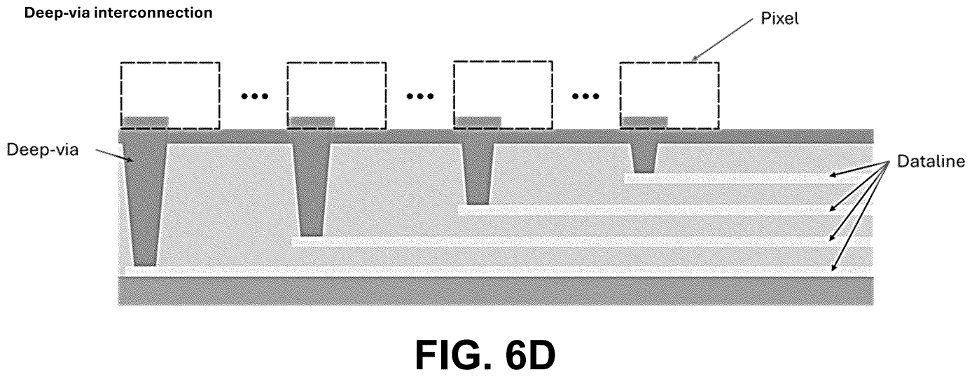

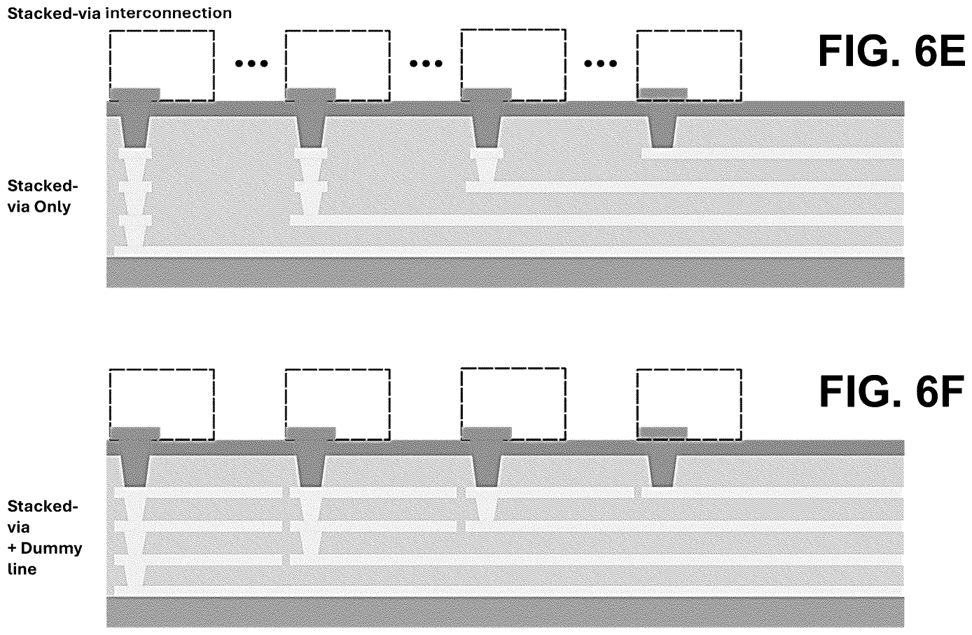

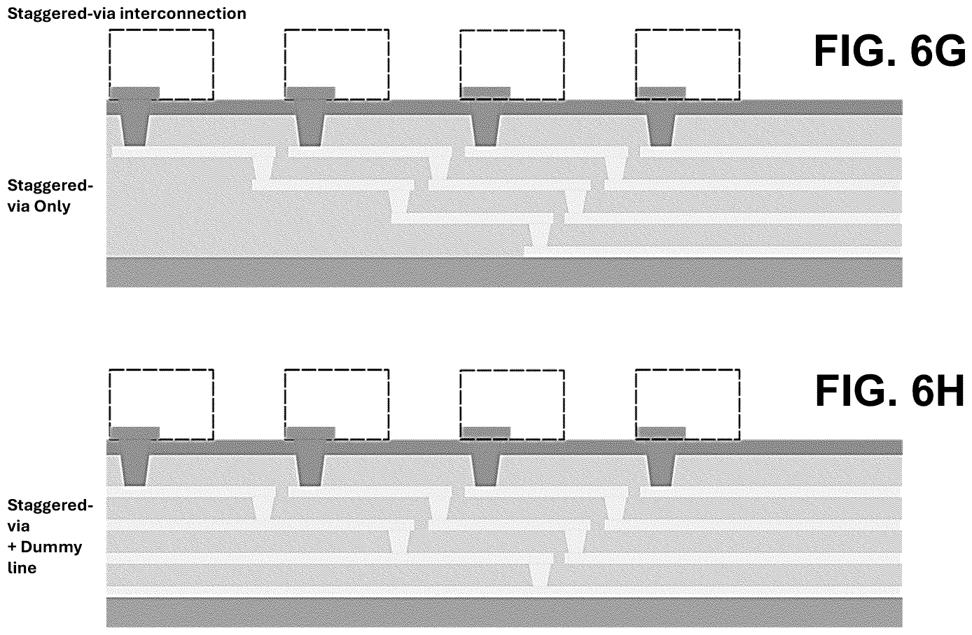

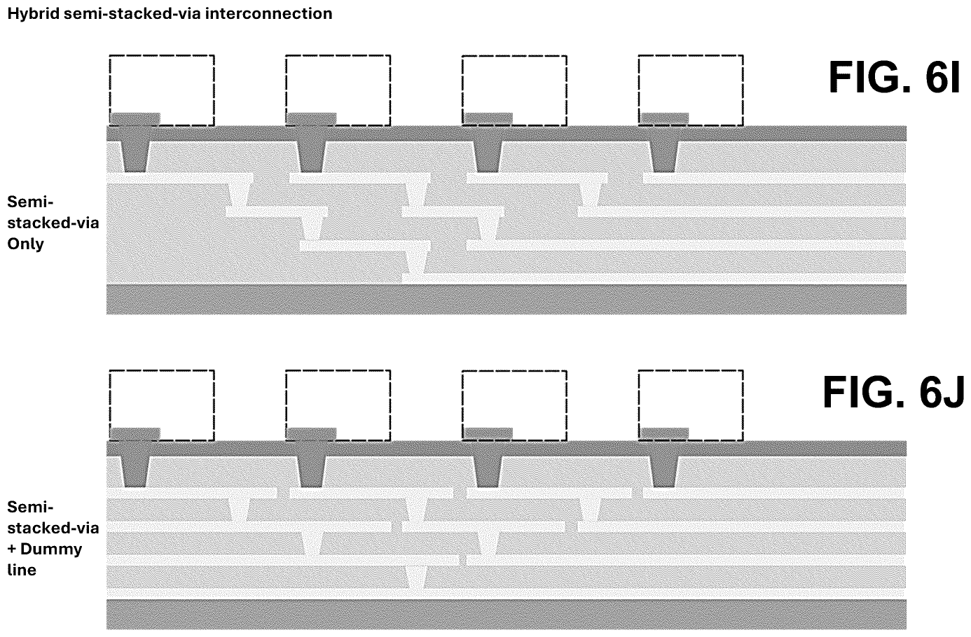

FIGS. 6A-6C show several variations of multi-layer VDATA line structures, with different VDATA line arrangements. FIG. 6A shows one possible VDATA line arrangement method where VDATA lines in different layers are aligned, leaving an array of space through which the emitted light from the bottom-emitting VOLET pixel can pass unobstructed. This arrangement by providing light-passing windows, may in some circumstance afford benefits including better transmittance and less haze.

FIG. 6B shows another possible arrangement method where VDATA lines in different layers are offset. This arrangement equally distributes the VDATA line traces across various layers, therefore may provide the benefit of creating a more flat surface topology for the top VOLET pixel structure, and may at some circumstance afford benefits including more uniform transmittance within each pixel, i.e., better in-pixel uniformity, and less haze.

FIG. 6C shows another possible arrangement where VDATA lines in different layers are perpendicular to each other. This arrangement allows the VDATA lines to be routed to different edges of the display panel, providing more flexibility in VDATA line routing and VDATA source driver placement.

It is noteworthy that these figures are only to provide a few examples of possible VDATA line arrangements. All possible VDATA arrangements that can be created in one VDATA trace layer and all combinations of possible VDATA arrangements that can be created in multiple VDATA trace layers are within the spirit of this concept. It is possible that by creating a certain VDATA trace arrangement in one or more layers, a certain beneficial optical effect can be achieved to enhance the device performance by increasing transmittance and reducing haze, that is also within the scope of this concept.

FIGS. 6D-6J illustrate several examples for forming electrical connections between VDATA lines, located in different metallization layers, and corresponding pixels distributed across a display panel.

FIG. 6D illustrates an example of a deep-via interconnection. In this configuration, VDATA lines in various layers are routed to a position beneath their target pixels. A single, in some cases high-aspect-ratio, via is then etched from the pixel's contact point through all intervening interlayer dielectric (ILD) layers to expose the target VDATA line. This process requires that the VDATA line material exhibits high etch selectivity with respect to the ILD material. Subsequently, a conductive material can be deposited within the via to establish a continuous electrical connection. This deposition method provides sufficient conformal coverage to prevent voids or breaks along the sidewalls of the deep via.

FIG. 6E illustrates an example of a stacked-via interconnection. In contrast to the deep-via method, this process involves a sequential formation of interconnects. After each ILD layer is deposited, a via is formed to the conductive layer below. A conductive pad, which may be part of the subsequent VDATA layer, can then be formed to fill the via and make contact with the underlying layer. This sequence can be repeated for each layer, creating a vertically aligned, stacked series of interconnects. This approach mitigates the need for high etch selectivity and the challenges associated with filling high-aspect-ratio vias.

FIG. 6F illustrates an example of a variation of the stacked-via interconnection of FIG. 6E. In addition to the conductive pads forming the stacked interconnects, additional non-functional conductive segments, or “dummy traces,” can be patterned in the VDATA layers. These dummy traces are designed to create a more uniform optical path throughout the pixel area, thereby promoting uniform light emission across the display panel.

FIG. 6G illustrates an example of a staggered-via interconnection. This process is similar to the sequential method of FIG. 6E, but the vias connecting successive layers are laterally offset or “staggered” rather than vertically aligned. The connection between layers can be made by a series of interconnects distributed horizontally. This staggered configuration can enhance reliability by preventing potential open circuits resulting from misalignment in a stacked structure and can reduce the cumulative topographical impact of a tall vertical stack.

FIG. 6H illustrates an example of a variation of the staggered-via interconnection of FIG. 6G. Similar to the example of FIG. 6F, this configuration incorporates dummy traces within the VDATA layers. These traces help to homogenize the optical environment for pixels, contributing to more uniform light emission across the panel.

FIG. 6I illustrates an example of a hybrid semi-staggered via interconnection. This configuration provides a balance between the stacked-via (FIG. 6E) and staggered-via (FIG. 6G) approaches. Vias are vertically aligned across alternating layers, rather than being fully stacked or fully staggered. This method reduces the height of any single vertical stack, mitigating topographical and stress-related issues, while limiting the lateral spread of interconnects. By confining the non-transmissive via structures to fewer lateral positions than a fully staggered approach, this embodiment can reduce light blockage and scattering effects.

FIG. 6J illustrates an example of a variation of the semi-staggered via interconnection of FIG. 6I. This configuration also incorporates dummy traces to enhance optical uniformity, similar to the embodiments described in FIGS. 6F and 6H.

### Top Emission and Transparent ADD-OLED Panels

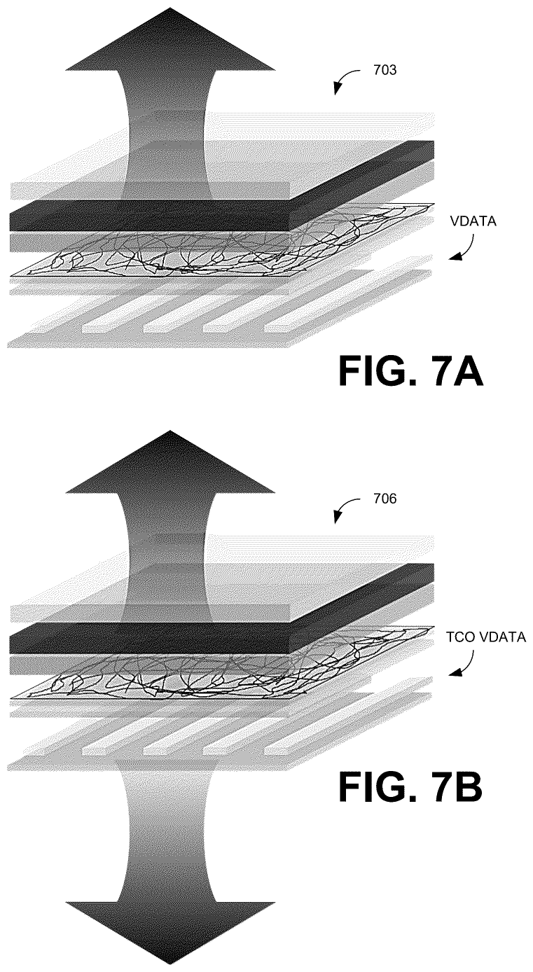

In the previous section, VDATA line routing schemes were discussed for ADD-OLED panels featuring a bottom-emission OLED, in which the light emits from the substrate side. In this configuration, the light emission will need to pass through the VDATA traces and therefore is affected by their structure, arrangement, and material composition. On the other hand, top emitting OLED can also be used for ADD-OLED panels, where the emitted light passes through the semi-transparent cathode at the top of the device. In this case, the transmittance of the VDATA lines running underneath a pixel of the ADD-OLED will not be a limiting factor, therefore, normal metals, including highly conductive metals, refractory metals as well as any combination of them that are commonly used in microelectronic and display industry, such as Al, Mo, Ag, Au, Cu, Ti, W, Cr, etc., can be used to form the VDATA lines. FIG. 7A graphically illustrates an example of a top emission ADD-OLED panel 703 with conventional metal VDATA lines. These metals may provide higher current carrying capacity and increase the performance of the top emission ADD-OLED by, for example, allowing for faster response time of an ADD-OLED pixel by reducing the RC time of VDATA signal transmission. Higher conductivity metals may also allow for thinner traces and therefore larger displays. It is important to note that the VOLET architecture still enables the top emission ADD-OLED display, due to its ability to separate the powering and controlling of pixels without the need for additional active components including TFTs. There are some technical challenges for a top emission OLED, including the requirement of semi-transparent cathode, which needs to be optimized for transmittance while minimizing IR drop due to more resistive cathode.

By combining the transparent VDATA lines in a bottom emitting ADD-OLED and the semi-transparent cathode in a top emitting ADD-OLED, with proper tuning of parameters including optical tuning of device stacks, a fully transparent ADD-OLED can be fabricated. The emission can be tuned for double-sided emission, or preferentially emitting to the substrate side (bottom emission) or to the cathode side (top emission). FIG. 7B graphically illustrates an example of a transparent ADD-OLED panel 706 with TCO VDATA lines that emits to both top and bottom sides of the panel. It is also possible to control the emission by optical tuning and/or light blocking to allow a transparent ADD-OLED to preferentially emit to one side (top or bottom) of the panel.

Source Voltage Driving Schemes for ADD-OLED Panels with Individual Pixel VDATA Control

In the most general common-anode and common-cathode configuration, the brightness of each pixel is controlled by a unique VDATA signal routed to the gate terminal of each VOLET pixel. Each VDATA line is routed to the outside edge of the panel display area and connected to a voltage source that feeds the appropriate VDATA voltage to each pixel. Multi-channel source drivers can drive a plurality of VDATA lines in order to control a large number of pixels.

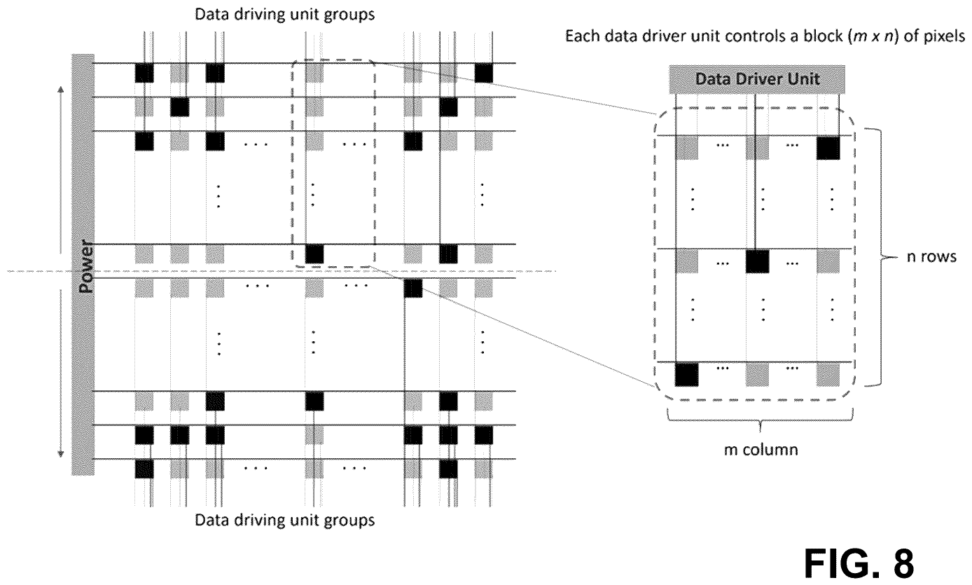

Without losing generality, FIG. 8 shows schematics of an addressing scheme of an ADD-OLED display, where a block of pixels comprises m columns by n rows, for a total of m×n pixels, all controlled by one Data Driver Unit. The Data Driver Unit can be a multi-channel source driver that can independently output at least m×n voltage signals to control this block of pixels. The timing control of the ADD-OLED panel is much more flexible than that of a typical AMOLED, thanks to the individually connected VDATA lines for each pixel. As shown in FIG. 8, every pixel can be updated independently without the need for a global refresh cycle for the ADD-OLED panel, and multiple pixels can be addressed and updated simultaneously regardless of their location within the panel (indicated here as the darker colored pixels). The Data Driver Unit can send updated VDATA signal at any time, depending on the source data, signal generation, and output updating sequence, which can take various forms and can run at very high frequency.

### Extending ADD-OLED Displays by Timing Blocks

A central feature of ADD-OLED displays is that every pixel is being driven by an independent voltage source at all times. This simplifies the panel design and drive scheme, and reduces power consumption. However, as can be seen from Table 1, pixel dimensions and patterning resolution place an upper limit on the maximum panel size. In a preceding section, it has been described how a multi-layer stack of VDATA lines can increase the number of pixels in a column if it can tolerate an increase in the number of processing steps and a decrease in the transparency through the VDATA layers. Another alternative is to use a timing scheme similar to conventional passive matrix displays to allow data driver units to address several blocks of pixels sequentially.

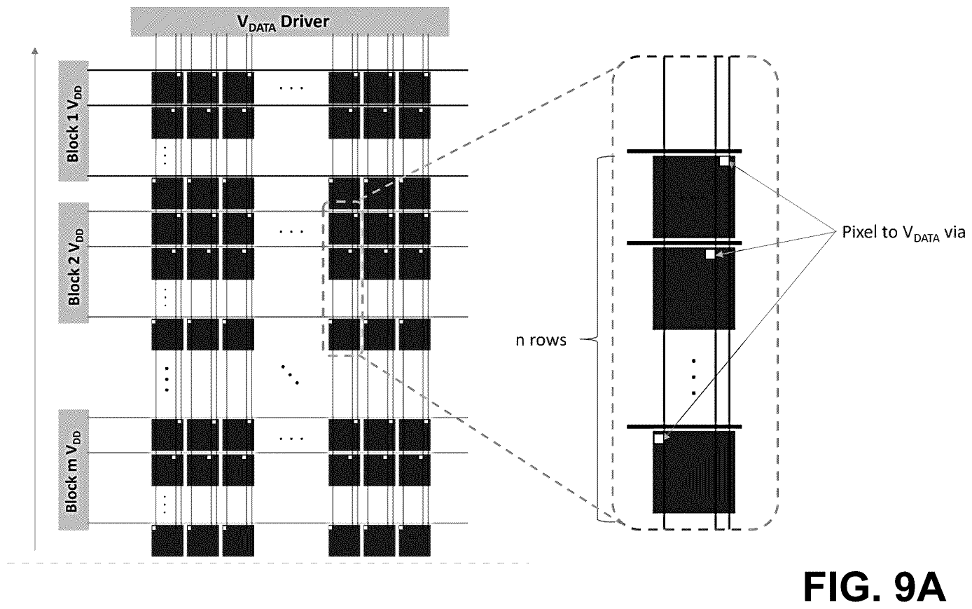

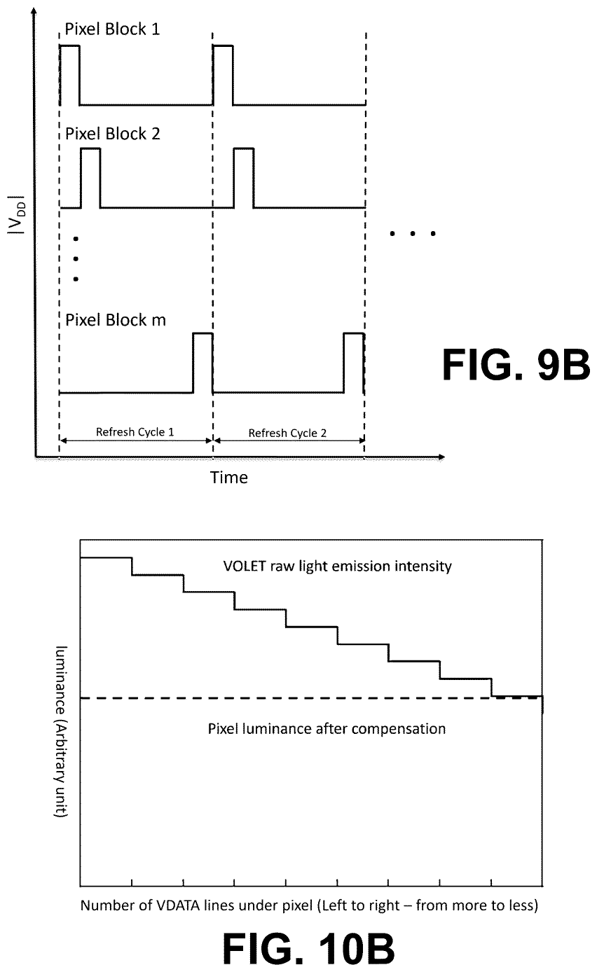

In this scheme, as schematically shown in FIG. 9A, each VDATA trace would extend continuously from the data driver down to the midpoint of the panel. Rather than be connected to only a single pixel, each trace can be connected to some number of pixels, m, in the column (m representing the number of repeat pixel blocks each includes n rows of pixels). Rather than a global common-anode for the whole display, each row of pixel blocks would have a common-anode. This would allow the rows of pixel blocks to be activated sequentially with each block being powered on for a period of time while all other rows are powered off, as shown in the timing graph of VDDs for each pixel block in FIG. 9B. The driving scheme for each row during this active period would proceed as described above. The effect of this sequential timing would be that only a fraction of the pixels would be on at any given time, requiring that pixels be driven to higher luminance to achieve the same perceived brightness and presents a trade-off between maximum display size and brightness/lifetime of the display.

As an example, from Table 1 it can be seen that an ADD-OLED display with 400 μm wide pixels and 2 μm/2 μm L/W would be limited to a maximum display height of 3.1 inches. However, if a sequential driving scheme was adopted with just 10 segments, a display height of 31 inches could be achieved-more than sufficient for a 65 in TV. The sequential timing would limit the duty cycle to 1/10, which would in turn require the OLEDs to be driven at a significantly higher brightness, but as OLED lifetimes continue to increase, the significantly lower production cost enabled by the ADD-OLED architecture could justify this tradeoff for certain applications.

Compensation Scheme for ADD-OLED Pixel Column with Varying Number of VDATA Traces

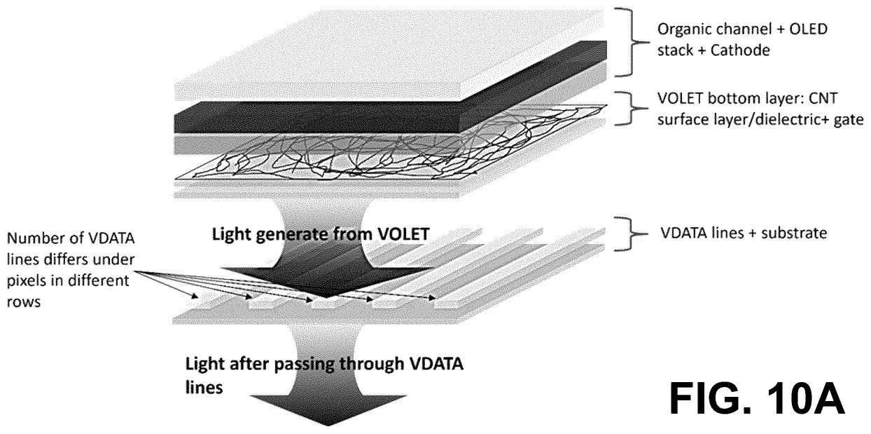

In this general configuration of the ADD-OLED display, the number of transparent VDATA lines running underneath a particular pixel will vary. Referring to FIGS. 4 and 5, it is easy to see that pixels closer to the edge of the display where all VDATA lines are routed out will have more VDATA lines running underneath them. Since the transparent VDATA lines have a finite transparency in the visible light spectrum, this will lead to more of the bottom emitted light being blocked for these pixels. Depending on the position of the pixels, the transparency penalty due to the varying number of VDATA lines running underneath each pixel can be precisely determined ahead of time, as depicted in FIGS. 10A and 10B, and the data signal adjusted accordingly for each pixel to maintain the overall uniformity of the display.

FIG. 10A shows one example of a bottom emission VOLET pixel in an ADD-OLED display panel, where the light generated in the OLED stack emits downward toward the substrate, and passes through the VDATA lines that run underneath the VOLET. The VDATA lines will block a portion of the emitted light. This portion will differ from pixel to pixel as the number of VDATA lines changes based on the location of the pixel. The transmittance of the VDATA lines can be tuned to transmit a majority of emitted light such that even pixels near the edge of the panel with the highest number of VDATA lines below them will have only a small fraction of their emitted light blocked. This transmittance value is stable and can be precisely calculated and measured, therefore, the transmission loss can be readily compensated.

FIG. 10B shows the effect of the proposed compensation concept for a single column. The straight line shows the target pixel luminance after the compensation is applied, indicating a uniform brightness level of all pixels in the column. In order to achieve this uniform brightness level, pixels near the edge of the display need to be set to a higher brightness in order to compensate for the additional VDATA traces below them. The staircased line depicts the luminance level of each pixel in the column needed to achieve a uniform luminance after passing through the VDATA lines. Pixels further from the edge have fewer VDATA lines below them, resulting in a higher fraction of the light being transmitted. The result is that pixels near the center of the display do not need to be driven as hard as pixels near the edge of the display.

This compensation concept can also be expanded to include ADD-OLED display panels with more than one layer of VDATA line trace layers, where examples are shown in FIG. 6. With multiple layers of VDATA lines, the transmittance of each pixel would be affected by every VDATA line at all layers that run underneath that pixel and each block the emitted light to some extent. The amount of blockage to the light emission can be precisely determined from the number and arrangement of these VDATA lines, and pixel compensation can be performed with proper algorithm, with the same principle as discussed above.

The abovementioned compensation scheme can be achieved at various levels. For example, a compensation algorithm can be incorporated in the image-rendering unit (IRU) including the GPU to make the pixel level adjustment when generating or rendering the image. Alternatively, compensation can be applied at the Graphics Control Unit (GCU) level, modifying the image data it receives. It is also possible to incorporate the compensation into the source driver that is directly in charge of generating driving signals for a particular group of pixels. The adjustment can be calculated in real time; alternatively, a lookup table (LUT) stored in a non-volatile memory unit can be used to calibrate the VDATA signal to correctly display intended brightness.

ADD-OLED Panels with Dummy VDATA Lines Under Pixels for Uniformity Control without Compensation

In the previous section, compensation schemes are discussed to address issues caused by the non-equal number of VDATA lines under ADD-OLED pixels in different regions of the panel blocking different fractions of the emitted light. The compensation scheme would need external support from the drivers and other driving electronic components of the display system. Alternatively, it is also possible to create an ADD-OLED display panel with intrinsically uniform emission for every pixel in the ADD-OLED display, by tuning the light transmittance of the pixels.

Because the difference in emission light blocking is in this case due to the different number of VDATA lines running underneath the pixels, the most straightforward way to achieve uniformity is to have an equal number of VDATA lines running underneath all the pixels. This can be accomplished by patterning dummy VDATA lines underneath pixels, so the total amount of VDATA lines per pixel—including both the functional VDATA lines as well as dummy VDATA lines—is consistent. This would ensure that every pixel would have the same optical characteristics and would achieve uniformity across the whole panel.

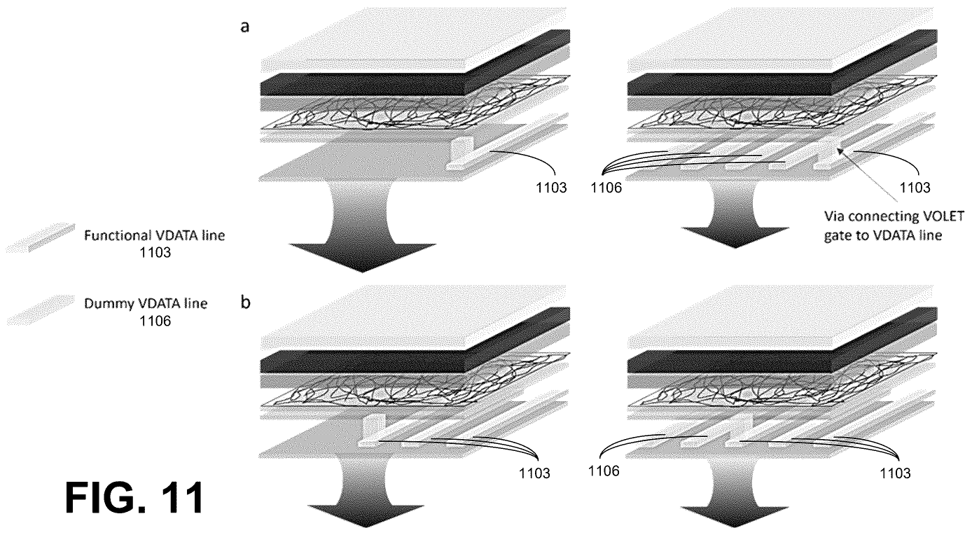

FIG. 11 shows the schematics of comparison between light emission without (left) and with (right) the inclusion of dummy VDATA lines in two different pixel positions: a) a single functional VDATA line 1103 beneath the pixel; b) multiple functional VDATA lines 1103 beneath the pixel. Without dummy VDATA lines 1106, more light passes through in scenario a) compared to b), therefore compensation is needed. With the addition of dummy VDATA lines 1106, the same amount of light passes through both a) and b), eliminating the need for compensation.

No additional processing steps are needed for the creation of dummy VDATA lines, since they can be created during the same step when the functional VDATA lines are created. Only minor modifications to the lithography masks are needed to create these dummy VDATA lines. Therefore, adding dummy VDATA lines to match the emission light blocking characteristics for every pixel in an ADD-OLED panel can be a low cost and effective way to improve the panel uniformity.

The downside to this approach is that the added dummy VDATA lines block more of the light emission from pixels near the center of the display, resulting in additional power consumption when compared to the above-mentioned compensation scheme. However, in circumstances where the VDATA lines are only blocking a small percentage of the emitted light, adding dummy traces will not cause significant power waste, while providing a low-cost and straightforward approach for achieving good panel uniformity.

ADD-OLED Panels with Pixels of Various Sizes and Shapes

The ADD-OLED architecture is compatible with a wide range of display panel parameters, including display panels with various pixel sizes and pixel shapes. Generally speaking, the size of pixels in an ADD-OLED panel would determine the maximum number of VDATA lines that can fit underneath a pixel, therefore decide the maximum number of pixels that can be placed in one column in which pixels can effectively route their VDATA lines out. Table 1 has shown some examples regarding the size of pixel and corresponding panel dimensions. On the other hand, in an ADD-OLED display panel, the limitations imposed by the shape of pixels are much less stringent. The shape of the pixels would affect the VDATA line arrangements running under pixels, in general, however, the ADD-OLED can assume any shape of pixel that fits the needs of that display.

In a typical display panel, the panel is intended to display information that is independent of the pixel shape, therefore the pixels are typically undiscernible. Pixels are typically arranged as a regular array of rectangles, while the actual light-emitting portion of the pixels typically can take any shape that fits within the pixel area. Since this type of display panel typically needs to have relatively high resolution to allow these undiscernible pixels to collectively form smooth images, the number of pixels needed would be high. This type of display would certainly work with the ADD-OLED architecture, however, due to the relatively small pixel size, it may be difficult to fit large number of VDATA lines underneath each pixel. Therefore, although ADD-OLED can work for such display types, to support high resolution, special considerations are needed, such as the multi-layered VDATA traces and ADD-OLED with timing blocks that are described earlier.

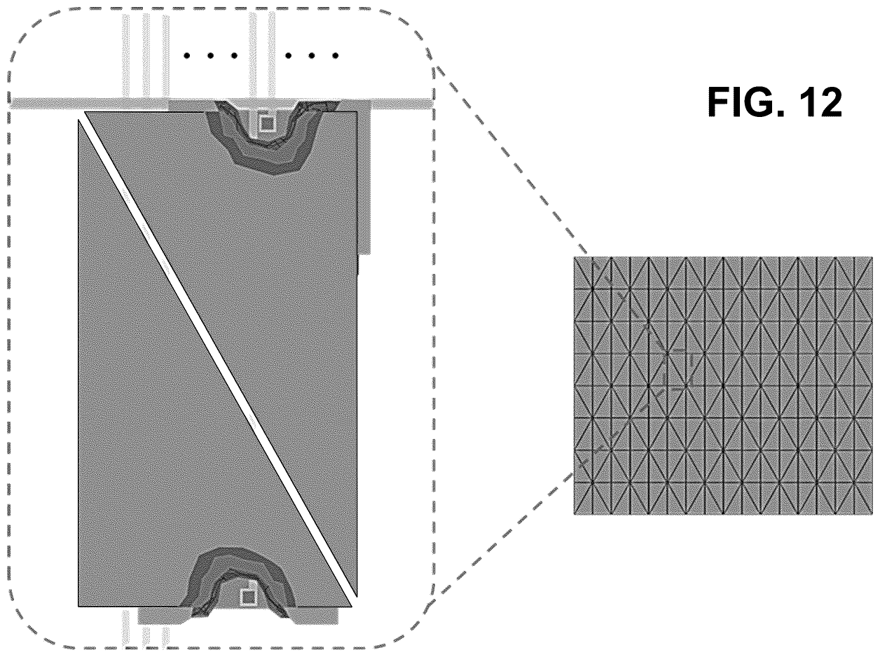

On the other hand, the ADD-OLED architecture is uniquely well suited for displays with large, visibly discernable pixel shapes. The recently proposed High Fill Factor, Arbitrary Size and Shape Vertical Light Emitting Transistor Pixels for Displays, Lighting and Signaling (see, International Publ. No. WO 2025/122930, entitled “Hybrid Active-Passive Matrix Devices for Displays, Lighting and Signaling,” having International App. No. PCT/U.S. Pat. No. 2,024,058964, filed Dec. 6, 2024, which is hereby incorporated by reference in its entirety) is one good example of such types of display. FIG. 12 shows an example of such a display with right triangle pixels that utilize the ADD-OLED architecture. VDATA lines are in a parallel arrangement running underneath each column of pixels, where the two triangle pixels split a rectangular area to form the unit cell with via holes at each end of the pixel to connect to their dedicated VDATA lines. It is noteworthy that FIG. 12 only provides one example of many possible shapes and layouts of pixels. Other possibilities include, but not limited to, ADD-OLED display panels with pixels having the shape of equilateral triangles, isosceles triangles, hexagons, etc. The VDATA line arrangements underneath these pixels can take different forms, such as vertical to one edge of the pixel, or at an arbitrary angle with one edge of the pixel. The position of the via holes for the VOLET gate terminal to make contact with the VDATA lines can also be placed at various locations within the pixel region.

Expanding on this concept, the hybrid VOLET automotive external display with mixed pixels and a monolithic hybrid VOLET/OLED automotive external light and display with mixed pixels and segments mentioned earlier can also be achieved by the ADD-OLED architecture. In these devices, those regions with traditional display pixels that are indistinguishable and typically require active-matrix addressing, would be replaced by pixels with ADD-OLED architecture. The ADD-OLED architecture would also be featured in larger segments that are typically passive-matrix addressed. The entire device can be fabricated using the same process on various substrates, whether glass, plastic, or other rigid or flexible materials. This includes the backplane process which would not require TFT fabrication thanks to the ADD-OLED architecture, and the VOLET-specific layers. OLED or other light emission layers, such as quantum dot LED (QD-LED), can be integrated during the same process or in separate runs for different regions.

### Fabrication Process for Active Direct Driving OLED (ADD-OLED) Display

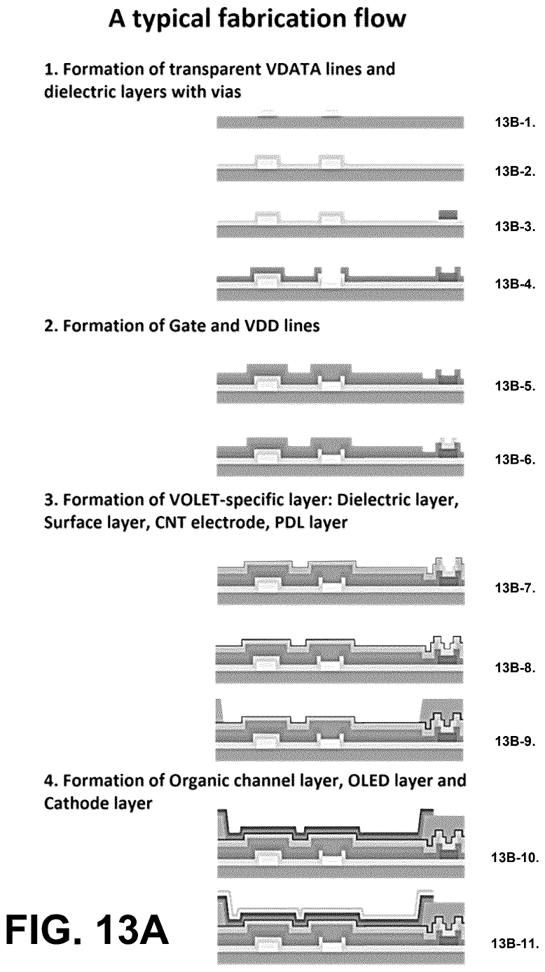

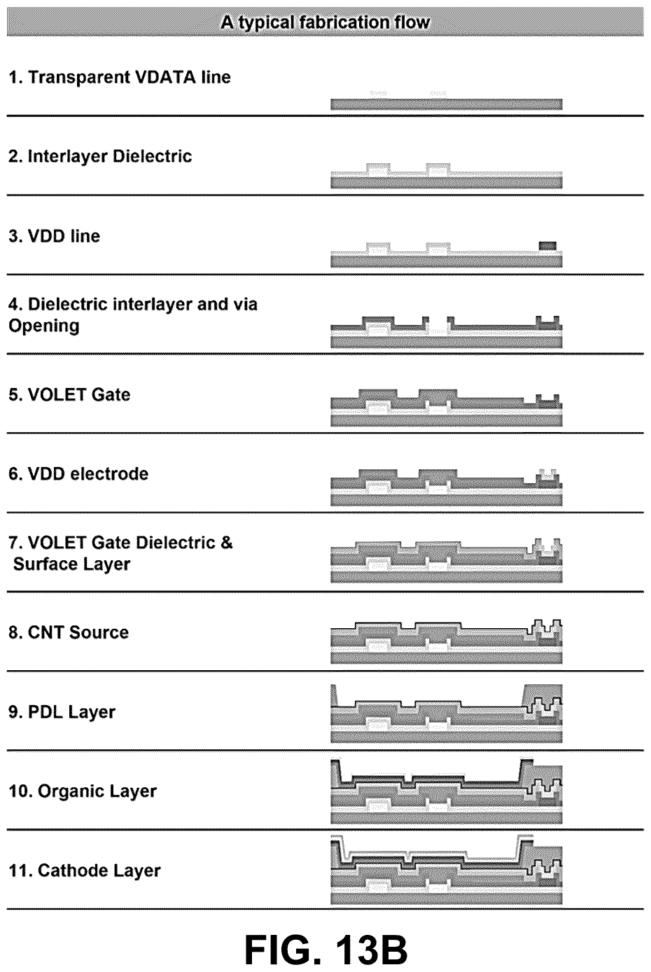

FIGS. 13A and 13B show an example of fabrication processing steps to manufacture a typical VOLET based Active Direct Driving OLED display, with transparent data voltage lines routing underneath the pixels. FIG. 13A depicts the processing steps by grouping the steps into functional units within the device, while FIG. 13B provides a detailed description of the layers formed within each step. A typical fabrication flow begins with formation of transparent VDATA lines and dielectric layers with vias. Beginning at 1 of 13B, transparent VDATA line(s) can be added to a substrate. Next, an interlayer dielectric can be added at 2 of 13B. A VDD line can be added at 3 of 13B and dielectric interlayer and via opening(s) formed at 4 of 13B. This can be followed by formation of gate and VDD lines. A VOLET gate is added at 5 of 13B and a VDD electrode is provided at 6 of 13B. Next, VOLET-specific layers are formed: dielectric layer, surface layer, CNT electrode, and PDL layer. A VOLET gate dielectric and surface layer is added at 7 of 13B. A CNT source is provided at 8 of 13B and a PDL layer is added at 9 of 13B. This is followed by formation of the organic channel layer, OLED layer and cathode layer. An organic layer is added at 10 of 13B and a cathode layer is added at 11 of 13B. It is notable that the fabrication does not require a TFT process, which simplifies production and lowers cost.

Note that this is only an example of one of many ways to fabricate the ADD-OLED panel. For example, in some embodiment, the ILD can consist of more than one thin film of different materials. In another embodiment, for some panels with smaller size the low pixel count, as the total current will be lower, the VDD lines can be formed together with the transparent VDATA line step, saving the need for a separate VDD line metal layer process, further saving the manufacturing cost.

In another embodiment, when the VDD lines are formed together with the transparent VDATA lines in one step, it is possible to overlay a pattern of conductive traces on top of the VDD line during the VOLET gate process, so that these two transparent conductive traces together form the VDD line, increasing the conductance of the VDD line to boost the current carrying capacity.

In the case of ADD-OLED panels with multiple layers of VDATA line traces, each subsequent layer of the transparent conductive oxide (TCO) would be deposited on top of the interlayer dielectric (ILD) that covers the previous layer of VDATA line traces, and patterned by lithography, to form that layer of VDATA lines. The ILD layers that separate the VDATA line traces layers are formed with via holes designed at appropriate locations that allows for the interconnection of the VDATA line layers with other conductive layers, e.g., allows for the bottom or lower VDATA line layers to be connected to upper or top layers, where the final bonding tabs would be formed for driver IC bonding.

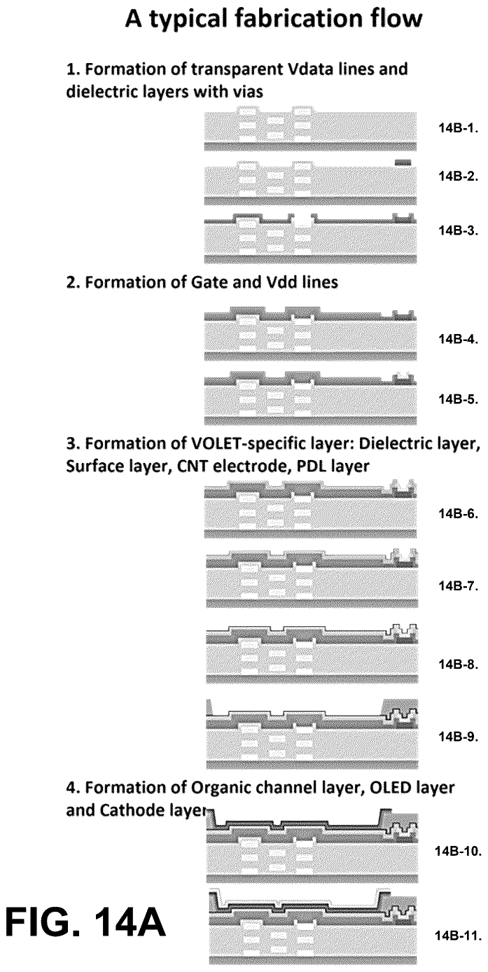

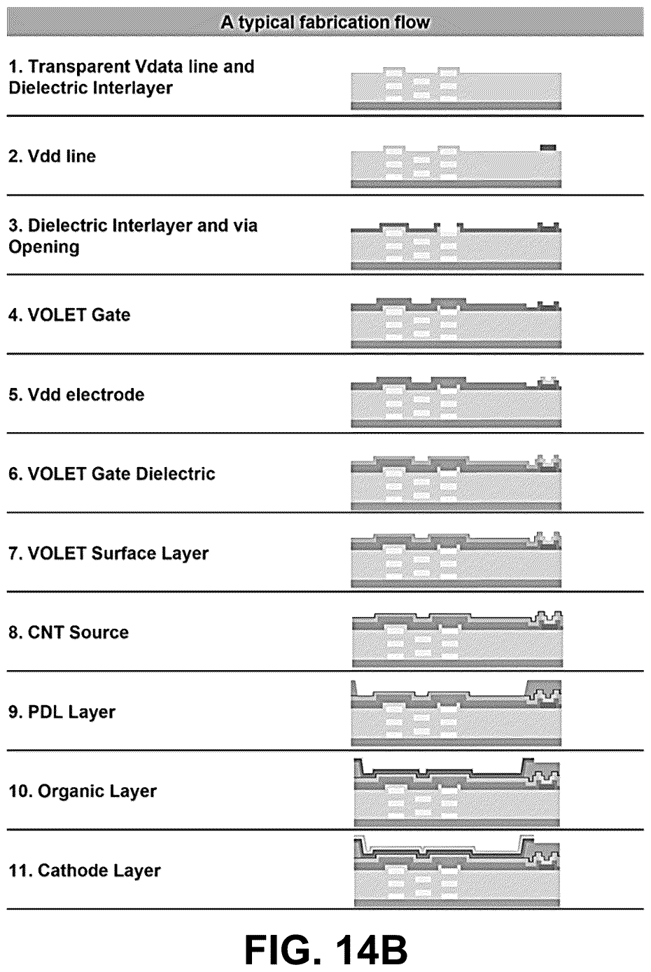

FIGS. 14A and 14B show fabrication processing steps to manufacture a VOLET based Active Direct Driving OLED display with multiple layers of transparent data voltage lines routing underneath the pixels. FIG. 14A explains the processing steps by grouping the steps into functional units within the device, while FIG. 14B provides a detailed description of the layers formed within each step. A typical fabrication flow begins with formation of transparent VDATA lines and dielectric layers with vias. Beginning at 1 of 14B, transparent VDATA line(s) and dielectric interlayer(s) can be added to a substrate. Next, a VDD line can be added at 2 of 14B and dielectric interlayer and via opening(s) formed at 3 of 14B. This can be followed by formation of gate and VDD lines. A VOLET gate is added at 4 of 14B and a VDD electrode is provided at 5 of 14B. Next, VOLET-specific layers are formed: dielectric layer, surface layer, CNT electrode, and PDL layer. A VOLET gate dielectric is formed at 6 of 14B and a VOLET surface layer is added at 7 of 14B. A CNT source is provided at 8 of 14B and a PDL layer is added at 9 of 14B. This is followed by formation of the organic channel layer, OLED layer and cathode layer. An organic layer is added at 10 of 14B and a cathode layer is added at 11 of 14B. In these figures shown are the vertically aligned VDATA lines layout scheme as depicted in FIG. 6A. Other VDATA layouts, including the offset-positioned VDATA lines as depicted in FIG. 6B, as well as the various-directional VDATA line routing scheme as depicted in FIG. 6C, should follow similar processing steps as well.

Deposition and photolithography followed by subtractive etch is a widely used process to form the fine features needed in the ADD-OLED panels, that includes the VDATA line traces. Alternatively, various methods that are known to form fine patterns, for example, inkjet printing followed by sintering, can also be used for the VDATA line formation as well as other steps in the ADD-OLED display device fabrication. All commonly employed semiconductor/dielectric/interconnect processing techniques are considered within the scope of ADD-OLED panel fabrication.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

The term “substantially” is meant to permit deviations from the descriptive term that don't negatively impact the intended purpose. Descriptive terms are implicitly understood to be modified by the word substantially, even if the term is not explicitly modified by the word substantially.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

Therefore, at least the following is claimed:

1. An active direct driving matrix device, comprising:
an array of VOLET pixels arranged to form an emissive display;
bus lines comprising at least one VDD line routed along edges of the array of VOLET pixels and a plurality of VDATA lines routed under the array of VOLET pixels, each VOLET pixel of the array of VOLET pixels connected to a corresponding VDATA line of the plurality of VDATA lines.

2. The active direct driving matrix device of claim 1, wherein the array of VOLET pixels share a common VDD-cathode voltage difference through the at least one VDD line.

3. The active direct driving matrix device of claim 1, wherein the plurality of VDATA lines and at least one VDD line are routed in different directions to a periphery of the emissive display.

4. The active direct driving matrix device of claim 1, wherein the array of VOLET pixels is arranged in rows and columns, with one or more VDD line extending along each row and the plurality of VDATA lines comprising corresponding VDATA lines extending to each VOLET pixel in that column.

5. The active direct driving matrix device of claim 4, wherein the corresponding VDATA lines extending to each VOLET pixel in a column extend a different length under the VOLET pixels in the column.

6. The active direct driving matrix device of claim 5, wherein the corresponding VDATA lines extending under the VOLET pixels in the column comprise at least two layers of corresponding VDATA lines separated by an insulating layer.

7. The active direct driving matrix device of claim 6, wherein the VDATA lines of the at least two layers are aligned, and are overlapping when viewed from a direction perpendicular to an emission surface of the VOLET pixel.

8. The active direct driving matrix device of claim 6, wherein the VDATA lines of the at least two layers are aligned, and have offsets without overlapping when viewed from a direction perpendicular to an emission surface of the VOLET pixel.

9. The active direct driving matrix device of claim 6, wherein the VDATA lines of the at least two layers are perpendicular between adjacent layers when viewed from a direction perpendicular to an emission surface of the VOLET pixel.

10. The active direct driving matrix device of claim 6, wherein a connection between a VOLET pixel and its corresponding VDATA line in one of the at least two layers comprises a stacked-via structure, the stacked-via structure comprising a plurality of vertically aligned vias extending through insulating layers separating the at least two layers of corresponding VDATA lines.

11. The active direct driving matrix device of claim 6, wherein a connection between a VOLET pixel and its corresponding VDATA line in one of the at least two layers comprises a staggered-via structure, wherein vias connecting successive conductive layers are laterally offset from one another.

12. The active direct driving matrix device of claim 6, wherein a connection between a VOLET pixel and its corresponding VDATA line in one of the at least two layers comprises a semi-staggered via structure, wherein vias are vertically aligned across a first set of adjacent insulating layers and are laterally offset across a second set of adjacent insulating layers.

13. The active direct driving matrix device of claim 4, wherein the corresponding VDATA lines extend from opposite sides of the array of VOLET pixels.

14. The active direct driving matrix device of claim 1, wherein the plurality of VDATA lines comprise a transparent conductive oxide or transparent conducting film.

15. The active direct driving matrix device of claim 1, wherein brightness of each VOLET pixel in the array of VOLET pixels is compensated based upon number of VDATA lines under that pixel.

16. The active direct driving matrix device of claim 1, comprising a plurality of dummy VDATA lines routed under the array of VOLET pixels, wherein a combined number of VDATA and dummy VDATA lines routed under each VOLET pixel of the array of VOLET pixels is equal.

17. The active direct driving matrix device of claim 16, wherein the plurality of dummy VDATA lines are patterned to substantially replicate a layout of the plurality of VDATA lines to normalize a parasitic capacitance or an optical transmittance for each VOLET pixel in the array of VOLET pixels.

18. The active direct driving matrix device of claim 16, wherein the dummy VDATA lines are electrically floating or are connected to a fixed potential.

19. The active direct driving matrix device of claim 1, wherein each VOLET pixel is visibly discernable to a user.

20. The active direct driving matrix device of claim 19, wherein each VOLET pixel has a shape of a triangle.

21. The active direct driving matrix device of claim 19, wherein each VOLET pixel comprises an arbitrary closed shape.

22. The active direct driving matrix device of claim 19, wherein the array of VOLET pixels consists of pixels with a variety of shapes.

23. The active direct driving matrix device of claim 1, wherein each VOLET pixel is visibly not discernable to a user.

24. The active direct driving matrix device of claim 1 formed on a common substrate, wherein a first portion of VOLET pixels are visibly discernable to a user, while a second portion of VOLET pixels are not visibly discernable to the user.

25. The active direct driving matrix device of claim 1, wherein a plurality of VOLET pixels are grouped together by connecting to VDD lines that are tethered together only within each group, and each group shares a common VDD-cathode voltage difference through the tethered VDD lines within its group.

26. The active direct driving matrix device of claim 25, wherein each group of VOLET pixels has the same or roughly similar number of pixels, and a pixel in one group is connected to a common VDATA line that is also connected to one pixel in another or each of the other groups of pixels.

27. The active direct driving matrix device of claim 26, wherein a drive timing scheme allows one group of VOLET pixels to be activated by a non-zero common VDD-cathode voltage difference through the tethered VDD line, while some or all of the other groups of VOLET pixels are deactivated by a common VDD-cathode voltage difference that is set to zero (0) through the tethered VDD lines.

28. The active direct driving matrix device of claim 25, wherein the VDD lines tethered together within each group are routed in a mesh configuration to improve voltage uniformity across the group.

29. The active direct driving matrix device of claim 1, wherein the at least one VDD line is routed in a mesh configuration to improve voltage uniformity across the group.

30. The active direct drive device of claim 1, wherein VDATA voltage signals applied to the array of VOLET pixels are only updated as needed by display content rather than frame by frame.

31. The active direct drive device of claim 30, wherein the VDATA voltage signals applied to any given VOLET pixel are a combination of continuous and pulsed voltages.

32. The active direct drive device of claim 1, wherein VDATA voltage signals are pulsed with a certain periodicity and duty cycle to allow the VOLET pixels to alternate between a non-emission state and an emission state of a certain magnitude, wherein VDATA pulse duration and voltage level both determine the overall average brightness of a given VOLET pixel.

33. The active direct drive device of claim 1, wherein the VDATA voltage signal of each of the array of VOLET pixels is adjusted in proportion to an expected current and luminance efficiency decay of a VOLET stack.

34. The active direct driving matrix device of claim 1, wherein the VDATA lines are disposed in a plurality of layers separated by interlayer dielectrics, and wherein the connection from a VOLET pixel to its corresponding VDATA line comprises a single deep via extending through the plurality of interlayer dielectrics.

35. A method of fabricating an active direct driving matrix device, comprising:
forming a first layer of VDATA lines over a substrate;
depositing a first insulating layer over the first layer of VDATA lines;
forming a second layer of VDATA lines over the first insulating layer;
depositing a second insulating layer over the second layer of VDATA lines; and
forming an array of VOLET pixels over the second insulating layer, wherein each VOLET pixel is electrically connected to a corresponding VDATA line in at least one of the first or second layers of VDATA lines.

36. The method of claim 35, wherein forming the electrical connection comprises forming a stacked-via structure by:
etching a first via through the first insulating layer to expose a VDATA line in the first layer;
forming a first conductive plug in the first via;
etching a second via through the second insulating layer, wherein the second via is substantially vertically aligned with the first via, to expose the first conductive plug; and
forming a second conductive plug in the second via.

37. The method of claim 35, wherein forming the electrical connection comprises forming a staggered-via structure by:
etching a first via through the first insulating layer to expose a VDATA line in the first layer;
forming a conductive pad on the first insulating layer that fills the first via and extends laterally; and
etching a second via through the second insulating layer to expose a portion of the conductive pad that is laterally offset from the first via.
